(19) United States
(12) Patent Application Publication
(10) Pub. No.: US 2023/0300333 A1
(43) Pub. Date: Sep. 21, 2023

(54) IMAGE PROCESSING DEVICE, IMAGE PROCESSING METHOD, AND COMPUTER-READABLE RECORDING MEDIUM STORING IMAGE PROCESSING PROGRAM

(71) Applicant: FUJITSU LIMITED, Kawasaki-shi (JP)

(72) Inventors: Tomonori KUBOTA, Kawasaki (JP); Takanori NAKAO, Kawasaki (JP); Yasuyuki MURATA, Shizuoka (JP)

(73) Assignee: FUJITSU LIMITED, Kawasaki-shi (JP)

(21) Appl. No.: 18/325,155

(22) Filed: May 30, 2023

Related U.S. Application Data
(63) Continuation of application No. PCT/JP2021/001047, filed on Jan. 14, 2021.

(51) Int. Cl. H04N 19/124; G06V 10/77; H04N 19/176

(52) U.S. Cl. CPC H04N 19/124; G06V 10/7715; H04N 19/176

(57) ABSTRACT

An image processing device includes: a memory; and a processor coupled to the memory and configured to: acquire a first feature map output from a hidden layer by forward propagation of image data; acquire a plurality of second feature maps output from the hidden layer by forward propagation of each of a plurality of pieces of decoded data obtained by sequentially encoding the image data by using different quantization values and thereafter decoding the encoded image data; calculate a degree of influence of each block of the image data on a recognition result by backpropagating each error between the first feature map and the plurality of second feature maps; and determine a quantization value of each block when the image data is encoded.

### CROSS-REFERENCE TO RELATED APPLICATION

This application is a continuation application of International Application PCT/JP2021/001047 filed on Jan. 14, 2021 and designated the U.S., the entire contents of which are incorporated herein by reference.

### FIELD

The embodiments discussed herein are related to an image processing device, an image processing method, and an image processing program.

### BACKGROUND

Commonly, when image data is recorded or transmitted, recording cost and transmission cost are reduced by reducing a data size by encoding processing.

Japanese Laid-open Patent Publication No. 2019-050896 and Japanese Laid-open Patent Publication No. 2020-003785 are disclosed as related art.

### SUMMARY

According to an aspect of the embodiments, an image processing device includes: a memory; and a processor coupled to the memory and configured to: acquire a first feature map output from a hidden layer by forward propagation of image data; acquire a plurality of second feature maps output from the hidden layer by forward propagation of each of a plurality of pieces of decoded data obtained by sequentially encoding the image data by using different quantization values and thereafter decoding the encoded image data; calculate a degree of influence of each block of the image data on a recognition result by backpropagating each error between the first feature map and the plurality of second feature maps; and determine a quantization value of each block when the image data is encoded.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of a system configuration of an image processing system;

FIG. 2 is a diagram illustrating an example of hardware configurations of an image processing device and a server device;

FIG. 3 is a first diagram illustrating an example of a functional configuration of an analysis unit of the image processing device;

FIG. 4 is a first diagram illustrating a specific example of processing of a convolutional neural network (CNN) unit and an important feature map generation unit;

FIG. 5 is a diagram illustrating a specific example of processing of an aggregation unit;

FIG. 6 is a diagram illustrating a specific example of processing of a quantization value map generation unit;

FIG. 7 is a first flowchart illustrating a flow of image processing by the image processing device;

FIG. 8 is a second diagram illustrating a specific example of processing of a CNN unit and an important feature map generation unit;

FIG. 9 is a second flowchart illustrating a flow of image processing by an image processing device;

FIG. 10 is a second diagram illustrating an example of a functional configuration of an analysis unit of an image processing device;

FIG. 11 is a diagram illustrating a specific example of processing of a CNN unit and a signal intensity calculation unit;

FIG. 12 is a third flowchart illustrating a flow of image processing by the image processing device;

FIG. 13 is a diagram for describing a setting value to be dynamically changed; and

FIG. 14 is a diagram illustrating a specific example of dynamic change processing of the setting value.

### DESCRIPTION OF EMBODIMENTS

Meanwhile, in a case of recording or transmitting image data for the purpose of use in recognition processing by artificial intelligence (AI), it is conceivable to perform encoding processing by increasing a compression ratio to a limit at which the AI may recognize an object to be recognized (for example, at a limit compression ratio).

However, when trying to calculate the limit compression ratio, it is assumed that an amount of calculation at the time of the encoding processing increases.

In one aspect, an object is to reduce an amount of calculation when encoding processing suitable for recognition processing by artificial intelligence (AI) is performed.

Hereinafter, each embodiment will be described with reference to the accompanying drawings. Note that, in the present specification and the drawings, components having substantially the same functional configuration are denoted by the same reference signs, and redundant description will be omitted.

### First Embodiment

### <System Configuration of Image Processing System>

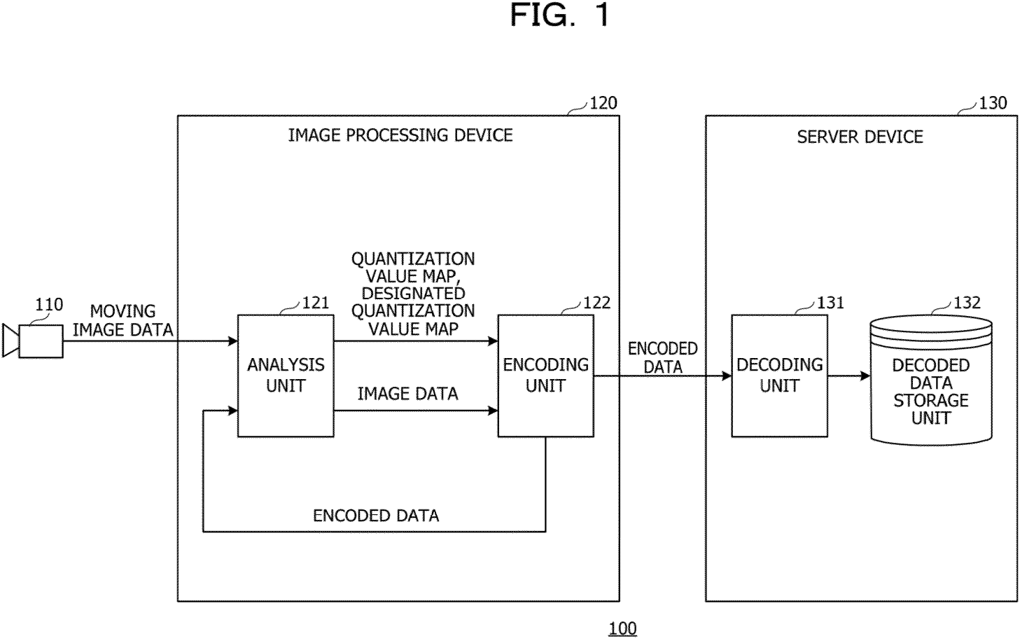

First, a system configuration of an image processing system including an image processing device according to a first embodiment will be described. FIG. 1 is a diagram illustrating an example of the system configuration of the image processing system. As illustrated in FIG. 1, an image processing system 100 includes an imaging device 110, an image processing device 120, and a server device 130. In the image processing system 100, the image processing device 120 and the server device 130 are communicably coupled via a network (not illustrated).

The imaging device 110 performs imaging at a predetermined frame period, and transmits moving image data to the image processing device 120. Note that the moving image data includes at least image data of a frame including an object targeted for recognition processing (object to be recognized) and image data of a frame (including only an object not to be recognized) not including the object targeted for the recognition processing (object to be recognized). Moreover, the moving image data may include a frame image that does not include any object.

An image processing program is installed in the image processing device 120, and when the image processing program is executed, the image processing device 120 functions as an analysis unit 121 and an encoding unit 122.

The analysis unit 121 includes a trained model that performs the recognition processing. The analysis unit 121 performs the recognition processing by inputting, to the trained model, image data or decoded data (decoded data obtained by decoding encoded data of a case where encoding processing is performed for the image data at different quantization values (also referred to as quantization steps)) of each frame of moving image data.

Furthermore, at the time of the recognition processing, the analysis unit 121 generates a map (referred to as an “important feature map”) indicating a degree of influence on a recognition result by performing motion analysis for the trained model by using, for example, an error back propagation method, and aggregates the degree of influence for each predetermined area. Note that the predetermined area mentioned here refers to a block used when the encoding processing is performed.

Furthermore, the analysis unit 121 instructs the encoding unit 122 to perform the encoding processing with a predetermined number of different quantization values for each block, and repeats similar processing for decoded data obtained by decoding encoded data of a case where the encoding processing is performed with each quantization value. Note that a set of the quantization values for each block, which is instructed to the encoding unit 122, is hereinafter referred to as a “quantization value map”.

For example, while changing image quality of the image data input to the trained model by changing the quantization value map, the analysis unit 121 aggregates the degree of influence of each block on the recognition result, for each piece of image data after the change.

Furthermore, the analysis unit 121 searches for an optimum quantization value of each block based on a change in an aggregated value due to the change in the quantization value map. Note that the optimum quantization value refers to a quantization value corresponding to a limit compression ratio, at which the recognition processing may be correctly performed for the object to be recognized included in the image data, among the predetermined number of different quantization values. A set of the quantization values corresponding to the limit compression ratio calculated for each block is hereinafter referred to as a “designated quantization value map”.

The encoding unit 122 encodes the image data of the corresponding frame of the moving image data by using the quantization value map instructed from the analysis unit 121, and returns generated encoded data to the analysis unit 121.

Furthermore, the encoding unit 122 encodes the image data of the corresponding frame of the moving image data by using the designated quantization value map instructed from the analysis unit 121, and transmits generated encoded data to the server device 130.

A decoding program is installed in the server device 130, and when the decoding program is executed, the server device 130 functions as a decoding unit 131.

The decoding unit 131 decodes the encoded data transmitted from the image processing device 120 to generate decoded data. The decoding unit 131 stores the generated decoded data in a decoded data storage unit 132.

### <Hardware Configurations of Image Processing Device and Server Device>

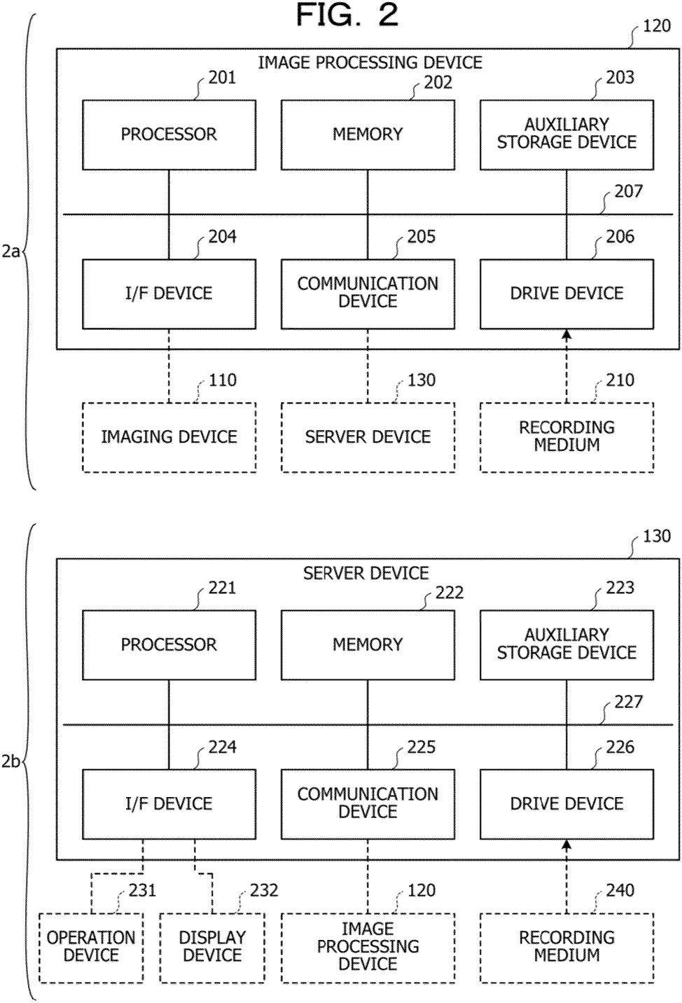

Next, hardware configurations of the image processing device 120 and the server device 130 will be described. FIG. 2 is a diagram illustrating an example of the hardware configurations of the image processing device and the server device.

Among these, 2a of FIG. 2 is a diagram illustrating an example of the hardware configuration of the image processing device. The image processing device 120 includes a processor 201, a memory 202, an auxiliary storage device 203, an interface (I/F) device 204, a communication device 205, and a drive device 206. Note that the respective pieces of hardware of the image processing device 120 are coupled to each other via a bus 207.

The processor 201 includes various arithmetic devices such as a central processing unit (CPU) or a graphics processing unit (GPU). The processor 201 reads various programs (for example, the image processing program and the like) into the memory 202 and executes the programs.

The memory 202 includes a main storage device such as a read only memory (ROM) or a random access memory (RAM). The processor 201 and the memory 202 form a so-called computer. The processor 201 executes the various programs read into the memory 202 to cause the computer to implement various functions.

The auxiliary storage device 203 stores various programs and various pieces of data used when the various programs are executed by the processor 201.

The I/F device 204 is a coupling device that couples the imaging device 110, which is an example of an external device, and the image processing device 120.

The communication device 205 is a communication device for communicating with the server device 130, which is an example of another device.

The drive device 206 is a device for setting a recording medium 210. The recording medium 210 mentioned here includes a medium that optically, electrically, or magnetically records information, such as a compact disc read only memory (CD-ROM), a flexible disk, or a magneto-optical disk. Furthermore, the recording medium 210 may include a semiconductor memory or the like that electrically records information, such as a ROM or a flash memory.

Note that the various programs to be installed in the auxiliary storage device 203 are installed when, for example, the distributed recording medium 210 is set in the drive device 206, and the various programs recorded in the recording medium 210 are read by the drive device 206. Alternatively, the various programs to be installed in the auxiliary storage device 203 may be installed by being downloaded from a network via the communication device 205.

On the other hand, 2b of FIG. 2 is a diagram illustrating an example of the hardware configuration of the server device 130. Note that since the hardware configuration of the server device 130 is substantially the same as the hardware configuration of the image processing device 120, differences from the image processing device 120 will be mainly described here.

A processor 221 reads, for example, a decoding program and the like into a memory 222 and executes the programs.

An I/F device 224 receives an operation for the server device 130 via an operation device 231. Furthermore, the I/F device 224 outputs a result of processing by the server device 130, and displays the result via a display device 232. Furthermore, a communication device 225 communicates with the image processing device 120.

### <Functional Configuration of Analysis Unit of Image Processing Device>

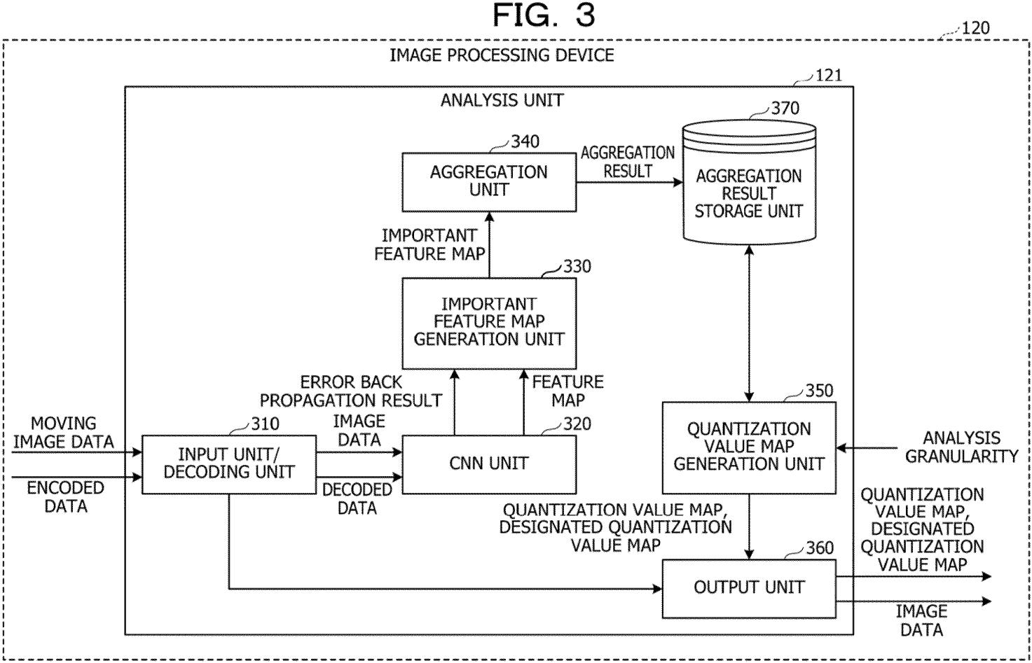

Next, a functional configuration of the analysis unit 121 of the image processing device 120 will be described. FIG. 3 is a first diagram illustrating an example of the functional configuration of the analysis unit of the image processing device. As illustrated in FIG. 3, the analysis unit 121 includes an input unit/decoding unit 310, a convolutional neural network (CNN) unit 320, an important feature map generation unit 330, an aggregation unit 340, a quantization value map generation unit 350, and an output unit 360.

The input unit/decoding unit 310 acquires image data of each frame of moving image data transmitted from the imaging device 110, and notifies the CNN unit 320 of the acquired image data. Furthermore, the input unit/decoding unit 310 acquires and decodes encoded data notified from the encoding unit 122, and then notifies the CNN unit 320 of the decoded data.

The CNN unit 320 includes the trained model that performs the recognition processing. The CNN unit 320 causes the trained model to be executed by inputting the image data or the decoded data.

The important feature map generation unit 330 is an example of first and second acquisition units, and acquires a feature map output from a layer of a hidden layer when the trained model is executed. Furthermore, the important feature map generation unit 330 generates an important feature map by the error back propagation method by using the acquired feature map.

For example, the important feature map generation unit 330 calculates an error between the feature map acquired when the image data is input and the feature map acquired when the decoded data is input. Furthermore, the important feature map generation unit 330 acquires an error back propagation result from an input layer of the trained model by backpropagating the calculated error. Moreover, the important feature map generation unit 330 generates an important feature map based on the acquired error back propagation result, and notifies the aggregation unit 340 of the generated important feature map.

Note that details of the method of generating the important feature map by the error back propagation method is disclosed in documents such as

“Selvaraju, Ramprasaath R., et al. “Grad-cam: Visual explanations from deep networks via gradient-based localization.”, The IEEE International Conference on Computer Vision (ICCV), 2017, pp. 618-626″, for example.

The aggregation unit 340 aggregates a degree of influence of each area on a recognition result in units of blocks based on the notified important feature map, and calculates an aggregated value of the degree of influence for each block. Furthermore, the aggregation unit 340 stores the calculated aggregated value of each block in an aggregation result storage unit 370 in association with the quantization value used for the encoding processing.

The quantization value map generation unit 350 is an example of a determination unit, and generates a quantization value map while sequentially changing the quantization value for each block. Note that it is assumed that a range of changing the quantization value is determined in advance. Furthermore, it is assumed that a change interval of the quantization value (for example, “analysis granularity”) is instructed by a user, for example, and is set in advance as a setting value.

Furthermore, the quantization value map generation unit 350 searches for a quantization value corresponding to the limit compression ratio for each block based on an aggregation result stored in the aggregation result storage unit 370, and generates a designated quantization value map.

The output unit 360 notifies the encoding unit 122 of the quantization value map or the designated quantization value map generated by the quantization value map generation unit 350. Furthermore, the output unit 360 notifies the encoding unit 122 of the image data of the corresponding frame of the moving image data.

### <Specific Example of Processing of CNN Unit and Important Feature Map Generation Unit>

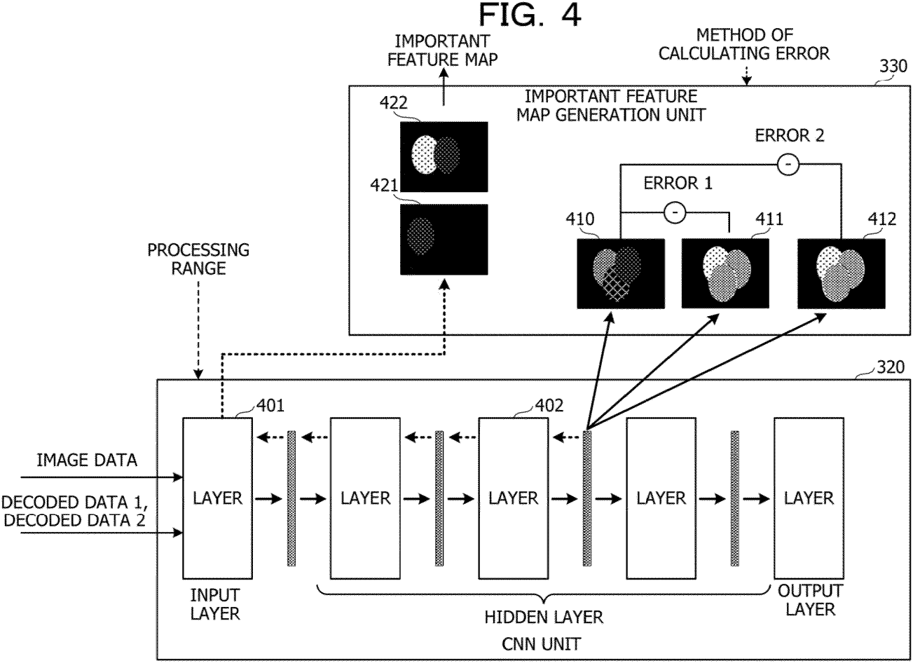

Next, a specific example of processing of the CNN unit 320 and the important feature map generation unit 330 among the respective units constituting the analysis unit 121 will be described. FIG. 4 is a first diagram illustrating the specific example of the processing of the CNN unit and the important feature map generation unit.

As illustrated in FIG. 4, the CNN unit 320 includes an input layer, hidden layers, and an output layer as the trained model, and when image data is input to a layer 401 of the input layer, the image data is processed in a forward propagation direction in each layer. With this configuration, a feature map 410 (an example of a first feature map) is output from a layer 402 of the hidden layer (see a solid thick arrow).

Similarly, when decoded data 1 is input to the layer 401 of the input layer, the decoded data 1 is processed in the forward propagation direction in each layer, and a feature map 411 (an example of a second feature map) is output from the layer 402 of the hidden layer (see a solid thick arrow). Note that the decoded data 1 refers to, for example, data obtained by performing the encoding processing on each block of the image data with a quantization value map including a quantization value Q₁ and thereafter decoding the encoded data by the input unit/decoding unit 310.

Similarly, when decoded data 2 is input to the layer 401 of the input layer, the decoded data 2 is processed in the forward propagation direction in each layer, and a feature map 412 (another example of the second feature map) is output from the layer 402 of the hidden layer (see a solid thick arrow). Note that the decoded data 2 refers to, for example, data obtained by performing the encoding processing on each block of the image data with a quantization value map including a quantization value Q₂ and thereafter decoding the encoded data by the input unit/decoding unit 310.

Hereinafter, although not illustrated in FIG. 4, decoded data 3, decoded data 4, ..., and the like are similarly processed, and feature maps are output. Note that it is assumed that the layer from which the feature map is output is instructed as a “processing range” by a user, for example, and is set in advance as a setting value.

Furthermore, as illustrated in FIG. 4, the important feature map generation unit 330 calculates each of errors (errors 1, 2, ...) between
· the feature map 410 output by processing the image data in the forward propagation direction, and
· each of the feature maps (feature maps 411, 412, ...) output by processing each piece of the decoded data (decoded data 1, 2, ...) in the forward propagation direction.

Furthermore, the important feature map generation unit 330 propagates each of the calculated errors (errors 1, 2, ...) in a backward direction from the layer 402 of the hidden layer. With this configuration, each of important feature maps (important feature maps 421, 422, ...) is output from the layer 401 of the input layer of the CNN unit 320 as an error back propagation result (see a dotted thick arrow). The important feature map generation unit 330 notifies the aggregation unit 340 of each of the important feature maps (important feature maps 421 and 422) output from the CNN unit 320.

In this manner, the CNN unit 320 does not execute the processing in the forward propagation direction up to a layer of the output layer but executes the processing up to an intermediate layer (the layer 402 of the hidden layer), and backpropagates, from the layer, the error calculated between the feature maps output from the layer. With this configuration, according to the image processing device 120 according to the first embodiment,
· processing in the forward propagation direction on the next and subsequent layers of the layer 402 of the hidden layer, and
· error back propagation up to the layer before the layer 402 of the hidden layer (the next layer in the case of being viewed in the forward propagation direction)
may be omitted, and an amount of calculation may be reduced when the encoding processing suitable for the recognition processing by artificial intelligence (AI) is performed.

In this manner, the important feature maps may be generated by the processing in the forward propagation direction up to the intermediate layer and the error back propagation from the intermediate layer based on a characteristic that, when the feature maps in the intermediate layer are the same, output from the layer of the output layer is also the same.

Note that, in the description above, a method of determining the intermediate layer (for example, a method of determining the “processing range”) has not been mentioned, but the processing range may be determined according to, for example, a tendency of a scene of the moving image data. For example, first, various processing ranges are set for the respective scenes, and a limit compression ratio is obtained by using important feature maps generated under the respective processing ranges. Then, after performing encoding with a quantization value corresponding to the limit compression ratio, decoding is performed, and a processing range in which recognition accuracy of the decoded data becomes allowable limit accuracy may be determined as an optimum processing range in the scene.

Alternatively, from a viewpoint of processing performance of the image processing device 120, processing ranges with which moving image data may be processed in real time may be searched for, and the maximum processing range with which the moving image data may be processed in real time may be determined as the optimum processing range.

Furthermore, although details of a method of calculating the error have not been mentioned in the description above, the important feature map generation unit 330 calculates the error between corresponding channels for feature maps of a plurality of channels output from the layer 402. At this time, the error may be calculated for all channels, or the error may be calculated for some channels. Furthermore, the error calculated between the corresponding channels may be simply added or may be weighted and added. Note that it is assumed that a calculation method to be used is instructed as the “method of calculating the error” from a user, and is set in advance as a setting value.

### <Specific Example of Processing of Aggregation Unit>

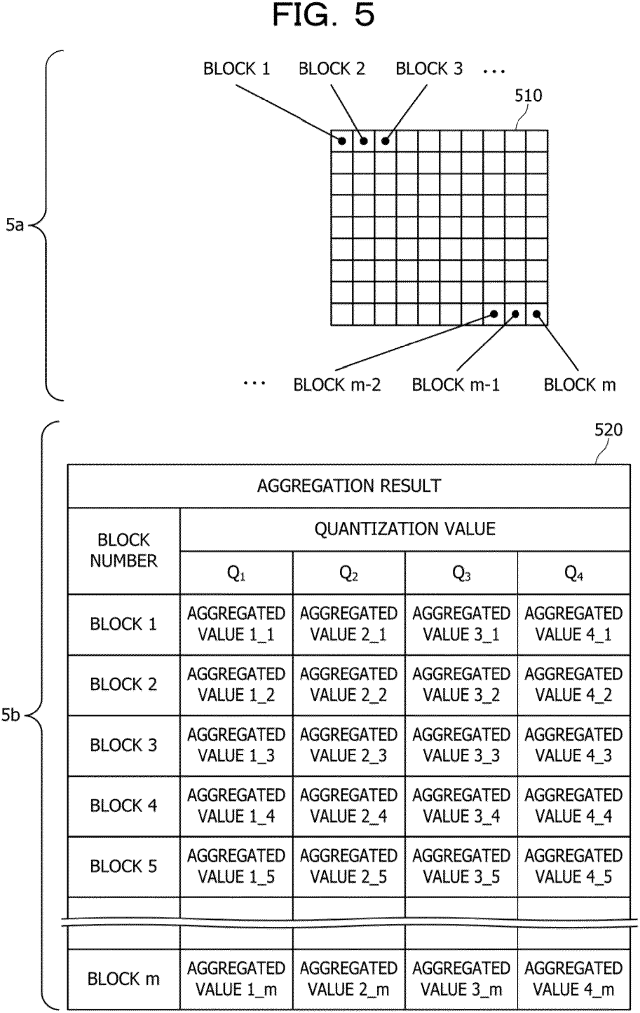

Next, a specific example of processing of the aggregation unit 340 among the respective units constituting the analysis unit 121 will be described. FIG. 5 is a diagram illustrating the specific example of the processing of the aggregation unit. Among these, 5a illustrates an arrangement example of blocks used when the encoding processing is performed on image data 510. As illustrated in 5a, in the present embodiment, for simplification of description, it is assumed that all the blocks in the image data 510 have the same dimensions. Furthermore, in the example of 5a, a block number of an upper left block of the image data 510 is assumed as “block 1”, and a block number of a lower right block is assumed as “block m”.

Furthermore, as illustrated in 5b, an aggregation result 520 calculated by the aggregation unit 340 includes “block number” and “quantization value” as information items.

In the “block number”, a block number of each block in the image data 510 is stored. In the “quantization value”, a predetermined number of quantization values settable when the encoding unit 122 performs the encoding processing are stored.

Note that, in the example of 5b, for simplification of description, only four types of quantization values (“Q₁” to “Q₄”) are described. However, it is assumed that four or more types of quantization values are settable in the encoding processing by the encoding unit 122.

Furthermore, in the aggregation result 520, an “aggregated value” obtained by
· performing the encoding processing for the image data 510 by using the corresponding quantization value, and
· being aggregated in the corresponding block based on the important feature map calculated when the recognition processing is performed for the decoded data
is stored in a field associated with the “block number” and the “quantization value”.

### <Specific Example of Processing by Quantization Value Map Generation Unit>

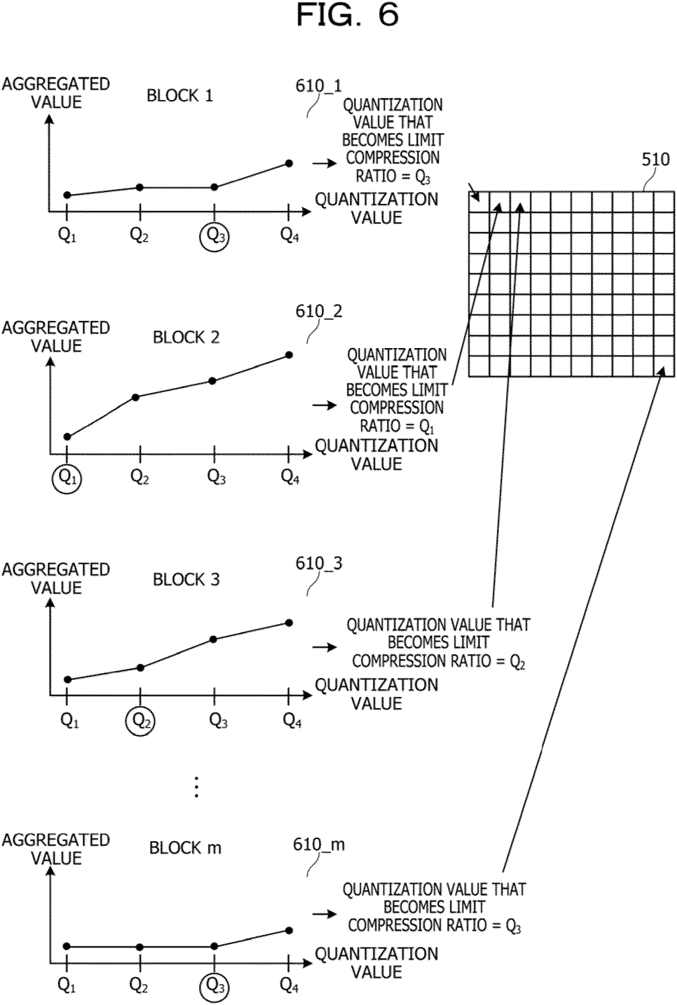

Next, a specific example of processing by the quantization value map generation unit 350 among the respective units constituting the analysis unit 121 will be described. FIG. 6 is a diagram illustrating the specific example of the processing by the quantization value map generation unit. In FIG. 6, graphs 610_1 to 610_m are graphs generated by plotting the aggregated value of each block included in the aggregation result 520, with the quantization value on a horizontal axis and the aggregated value on a vertical axis.

As illustrated in the graphs 610_1 to 610_m, a change in the aggregated value in the case where the encoding processing is performed by using the quantization value differs for each block. The quantization value map generation unit 350 determines, for example, the quantization value that satisfies any of the following conditions:
· in a case where the magnitude of the aggregated value exceeds a predetermined threshold,
· in a case where an amount of change in the aggregated value exceeds a predetermined threshold,
· in a case where a slope of the aggregated value exceeds a predetermined threshold, or
· in a case where a change in the slope of the aggregated value exceeds a predetermined threshold,
as the quantization value corresponding to the limit compression ratio of each block.

The example of FIG. 6 indicates that the quantization value map generation unit 350 determines the quantization value corresponding to the limit compression ratio as “Q₃” based on the graph 610_1. Furthermore, the example of FIG. 6 indicates that the quantization value map generation unit 350 determines the quantization value corresponding to the limit compression ratio as “Q₁” based on the graph 610_2. Furthermore, the example of FIG. 6 indicates that the quantization value map generation unit 350 determines the quantization value corresponding to the limit compression ratio as “Q₂” based on the graph 610_3. Moreover, the example of FIG. 6 indicates that the quantization value map generation unit 350 determines the quantization value corresponding to the limit compression ratio as “Q₃” based on the graph 610_m.

The example of FIG. 6 indicates a state where the quantization values corresponding to the limit compression ratio are set for the blocks 1 to m in the image data 510 and the designated quantization value map is generated.

### <Flow of Image Processing>

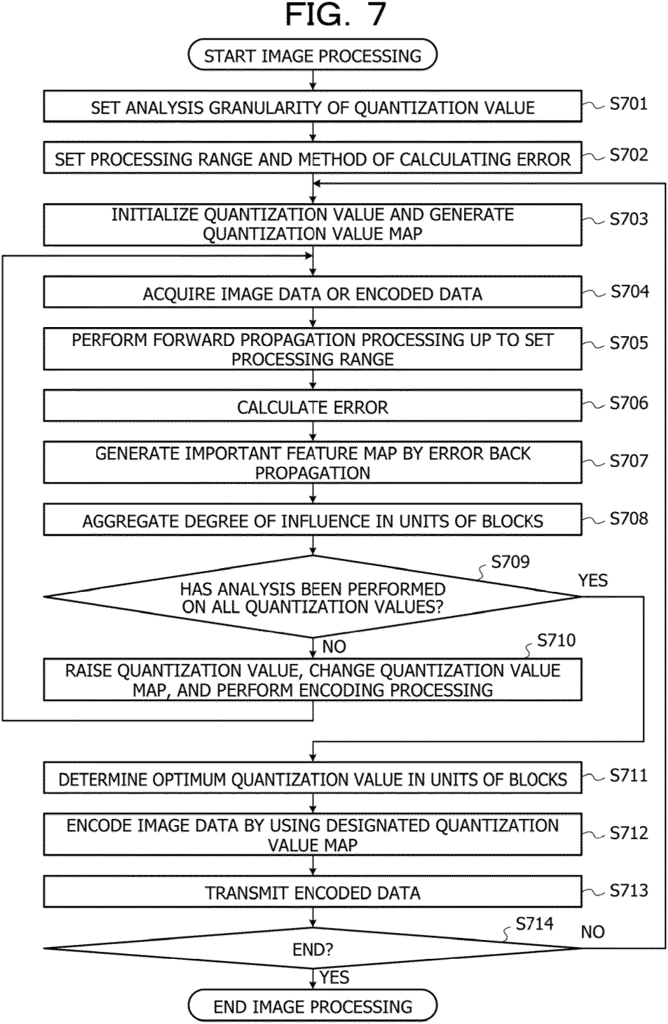

Next, a flow of image processing by the image processing device 120 will be described. FIG. 7 is a first flowchart illustrating the flow of the image processing by the image processing device.

In Step S701, the analysis unit 121 sets analysis granularity of a quantization value.

In Step S702, the analysis unit 121 sets a processing range and a method of calculating an error.

In Step S703, the analysis unit 121 determines that acquisition of moving image data imaged by the imaging device 110 may be started. Furthermore, in a case where the acquisition of the moving image data has already been started, the analysis unit 121 determines that the acquisition of the moving image data may be continued. With this configuration, the analysis unit 121 initializes the quantization value before acquiring image data of the next frame and generates a default quantization value map.

In Step S704, the analysis unit 121 acquires the image data or encoded data. Furthermore, in a case where the encoded data is acquired, the analysis unit 121 decodes the encoded data and generates decoded data.

In Step S705, the analysis unit 121 processes the image data or the decoded data up to the set processing range in the forward propagation direction, and outputs a feature map.

In Step S706, the analysis unit 121 calculates an error between the feature map output by processing the image data in the forward propagation direction and the feature map output by processing the decoded data in the forward propagation direction.

In Step S707, the analysis unit 121 generates an important feature map by error back propagation.

In Step S708, the analysis unit 121 aggregates the generated important feature maps in units of blocks and stores them in the aggregation result storage unit 370.

In Step S709, the analysis unit 121 determines whether or not analysis has been performed for all the predetermined number of quantization values that are settable in the encoding unit 122. In a case where it is determined in Step S709 that there is a quantization value for which analysis has not been performed (in the case of NO in Step S709), the processing proceeds to Step S710.

In Step S710, the analysis unit 121 raises the quantization value and changes the quantization value map. Furthermore, the encoding unit 122 performs the encoding processing for the image data by using the changed quantization value map and generates encoded data. Thereafter, the processing returns to Step S704.

On the other hand, in a case where it is determined in Step S709 that analysis has been performed for all the quantization values (in the case of YES in Step S709), the processing proceeds to Step S711.

In Step S711, the analysis unit 121 searches for an optimum quantization value in units of blocks and generates a designated quantization value map.

In Step S712, the encoding unit 122 encodes the image data by using the generated designated quantization value map and generates encoded data.

In Step S713, the encoding unit 122 transmits the generated encoded data to the server device 130.

In Step S714, the analysis unit 121 determines whether or not the image processing is to be ended. In a case where it is determined in Step S714 that the image processing is not to be ended (in the case of NO in Step S714), the processing returns to Step S703, and the quantization value is initialized and a quantization value map is generated before image data of the next frame in the moving image data is acquired.

On the other hand, in a case where it is determined in Step S704 that the image processing is to be ended (in the case of YES in Step S714), the image processing is ended.

As is clear from the above description, the image processing device 120 according to the first embodiment acquires the first feature map output from the hidden layer of the CNN unit by forward propagation of the image data in the CNN unit. Furthermore, the image processing device 120 according to the first embodiment acquires the plurality of second feature maps output from the hidden layer by forward propagation of each of the plurality of pieces of decoded data obtained by sequentially encoding the image data by using the different quantization values and then decoding the encoded image data in the CNN unit. Furthermore, the image processing device 120 according to the first embodiment calculates the degree of influence of each block of the image data on the recognition result by backpropagating each error between the first feature map and the second feature map, and determines the quantization value of each block when the image data is encoded.

In this manner, in the first embodiment, when the encoding processing suitable for the recognition processing by AI is performed, the processing in the forward propagation direction is not executed up to the output layer but is executed up to the layer of the hidden layer, and the error calculated between the feature maps output from the layer is backpropagated from the layer.

With this configuration, according to the first embodiment, it is possible to reduce the amount of calculation when the encoding processing suitable for the recognition processing by AI is performed.

### Second Embodiment

In the first embodiment described above, the degree of influence of each block of the image data on the recognition result is calculated by the back propagation of the error between the feature maps output from the hidden layer. However, the feature map in the hidden layer includes information to be removed by processing in the forward propagation direction on the layers after the hidden layer.

Thus, in a second embodiment, when the error between the feature maps output from the hidden layer is backpropagated, the information to be removed is removed and then backpropagated. Hereinafter, regarding the second embodiment, differences from the first embodiment described above will be mainly described.

### <Specific Example of Processing of CNN Unit and Important Feature Map Generation Unit>

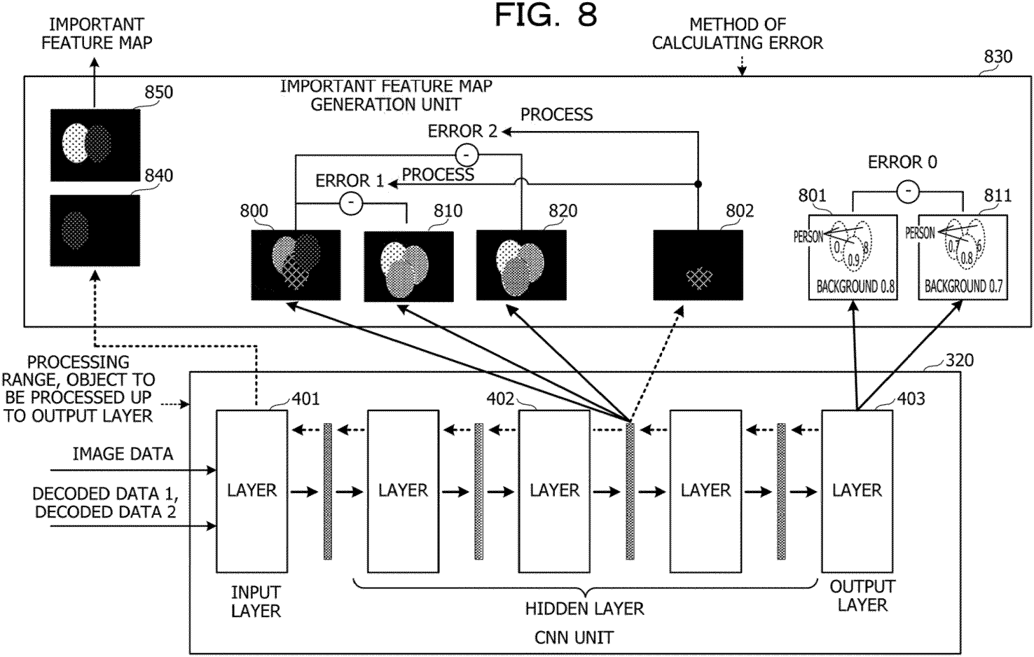

First, a specific example of processing of a CNN unit and an important feature map generation unit among the respective units constituting an analysis unit 121 of an image processing device 120 according to the second embodiment will be described. FIG. 8 is a second diagram illustrating the specific example of the processing of the CNN unit and the important feature map generation unit.

As illustrated in FIG. 8, a CNN unit 320 includes an input layer, hidden layers, and an output layer as a trained model, and when image data is input to a layer 401 of the input layer, the image data is processed in a forward propagation direction in each layer, and a feature map 800 is output from a layer 402 of the hidden layer. Furthermore, the image data is processed in the forward propagation direction also in layers after the layer 402 of the hidden layer, and an output result 801 is output from a layer 403 of the output layer.

Similarly, when decoded data 1 is input to the layer 401 of the input layer, the decoded data 1 is processed in the forward propagation direction in each layer, and a feature map 810 is output from the layer 402 of the hidden layer. Furthermore, the decoded data 1 is processed in the forward propagation direction also in the layers after the layer 402 of the hidden layer, and an output result 811 is output from the layer 403 of the output layer.

Moreover, when decoded data 2 is input to the layer 401 of the input layer, the decoded data 2 is processed in the forward propagation direction in each layer, and a feature map 820 is output from the layer 402 of the hidden layer.

Hereinafter, although not illustrated in FIG. 8, processing similar to that on the decoded data 2 is performed on decoded data 3, decoded data 4, ..., and the like, and each of feature maps are output from the layer 402 of the hidden layer.

Note that, in the present embodiment, it is assumed that the layer from which the feature map is output is instructed as a “processing range” by a user, for example, and is set in advance as a setting value. Furthermore, it is assumed that an object subjected to the processing in the forward propagation direction up to the layer 403 of the output layer (in the example of FIG. 8, the image data and the decoded data 1) is instructed as an “object to be processed up to the output layer” by a user, for example, and is set in advance as a setting value.

Furthermore, an important feature map generation unit 830 is an example of first to third acquisition units, and as illustrated in FIG. 8, calculates an error (error 0) between
· the output result 801 output by the layer 403 of the output layer by processing the image data in the forward propagation direction, and
· the output result 811 output from the layer 403 of the output layer by processing the decoded data 1 in the forward propagation direction.

Furthermore, the important feature map generation unit 830 backpropagates the calculated error (error 0) up to the layer before the layer 402 of the hidden layer (the next layer in the case of being viewed in the forward propagation direction). With this configuration, a feature map 802 (an example of a third feature map) is output as an error back propagation result from the layer before the layer 402 of the hidden layer, and the important feature map generation unit 830 acquires the feature map 802 output from the CNN unit 320.

Furthermore, as illustrated in FIG. 8, the important feature map generation unit 830 calculates an error (error 1) between
· the feature map 800 output from the layer 402 of the hidden layer by processing the image data in the forward propagation direction, and
· the feature map 810 output from the layer 402 of the hidden layer by processing the decoded data 1 in the forward propagation direction.

Moreover, the important feature map generation unit 830 processes the calculated error (error 1) by using the acquired feature map 802, and backpropagates the processed error 1 from the layer 402 of the hidden layer. With this configuration, an important feature map 840 is output as an error back propagation result from the layer 401 of the input layer of the CNN unit 320, and the important feature map generation unit 830 notifies an aggregation unit 340 of the important feature map 840 output from the CNN unit 320.

Similarly, as illustrated in FIG. 8, the important feature map generation unit 830 calculates an error (error 2) between
· the feature map 800 output from the layer 402 of the hidden layer by processing the image data in the forward propagation direction, and
· the feature map 820 output from the layer 402 of the hidden layer by processing the decoded data 2 in the forward propagation direction.

Furthermore, the important feature map generation unit 830 processes the calculated error (error 2) by using the acquired feature map 802, and backpropagates the processed error 2 from the layer 402 of the hidden layer. With this configuration, an important feature map 850 is output as an error back propagation result from the layer 401 of the input layer of the CNN unit 320, and the important feature map generation unit 830 notifies the aggregation unit 340 of the important feature map 850 output from the CNN unit 320.

Hereinafter, although not illustrated in FIG. 8, the decoded data 3, the decoded data 4, ..., and the like are similarly processed, and each of important feature maps is output.

In this manner, in view of the fact that the feature maps 800, 810, 820, ... output from the layer 402 of the hidden layer include information to be removed by the processing in the forward propagation direction on the layers after the layer 402 of the hidden layer, in the second embodiment,
· at least for one piece of image data and one piece of decoded data (for example, the decoded data 1), the processing in the forward propagation direction is performed up to the layer 403 of the output layer, and each output result output from the layer 403 of the output layer is acquired, and
· an error between the acquired output results is backpropagated up to the layer before the layer 402 of the hidden layer.

With this configuration, in the second embodiment, the information to be removed by the processing in the forward propagation direction on the layers after the layer 402 of the hidden layer may be visualized as the feature map 802.

Then, processing of removing the information to be removed after the layer 402 of the hidden layer from the errors 1 and 2 is performed, and the processed errors 1 and 2 are backpropagated, whereby a more accurate important feature map may be acquired from the layer 401 of the input layer.

Note that, “removing the information to be removed after the layer 402 of the hidden layer from the errors 1 and 2” refers to that, among error values of the respective areas of the errors 1 and 2, an error value of an area where the information to be removed after the layer 402 of the hidden layer is positioned is set to zero.

### <Flow of Image Processing>

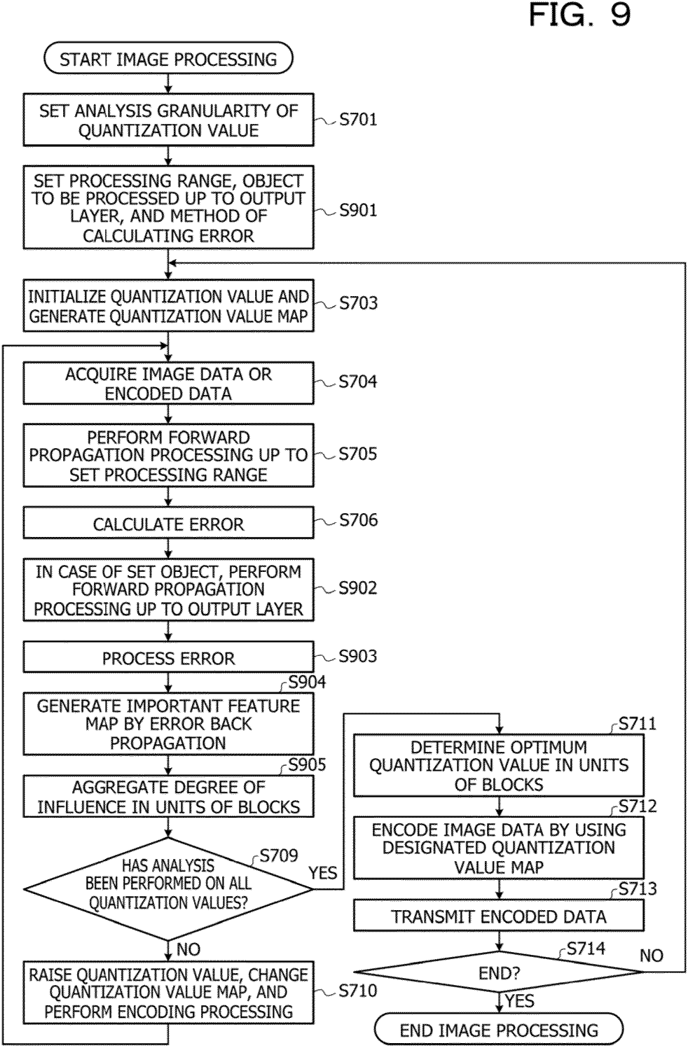

Next, a flow of image processing by the image processing device 120 will be described. FIG. 9 is a second flowchart illustrating the flow of the image processing by the image processing device. Differences from the first flowchart described with reference to FIG. 7 are Steps S901 and S902 to S904.

In Step S901, the analysis unit 121 sets a processing range and an object to be processed up to the output layer (for example, the image data and the decoded data 1). Furthermore, the analysis unit 121 sets a method of calculating an error.

In Step S902, in a case where the image data or the decoded data being processed is the object to be processed up to the output layer (for example, the image data or the decoded data 1), the analysis unit 121 performs the processing in the forward propagation direction up to the layer of the output layer. Furthermore, in a case where an error (for example, the error 0) may be calculated by using the output result output from the layer of the output layer, the analysis unit 121 calculates the error (for example, the error 0) and acquires information to be removed by backpropagating the calculated error (for example, the error 0).

In Step S903, the analysis unit 121 processes the error (for example, the errors 1, 2, ...) calculated in Step S706 by using the information to be removed.

In Step S904, the analysis unit 121 backpropagates the processed error (for example, the processed errors 1, 2, ...) and generates an important feature map.

As is clear from the above description, the image processing device 120 according to the second embodiment performs the processing in the forward propagation direction up to the layer of the output layer for the specified image data and decoded data, and calculates the error by using the output result output from the layer of the output layer. Furthermore, the image processing device 120 according to the second embodiment acquires the information to be removed (third feature map) after the predetermined layer of the hidden layer by backpropagating the error calculated by using the output result up to the layer before the predetermined layer of the hidden layer. Moreover, the image processing device 120 according to the second embodiment performs the processing of removing the information to be removed from the error between the feature maps output from the predetermined layer of the hidden layer, and backpropagates the processed error, thereby calculating the degree of influence of each block of the image data on the recognition result.

With this configuration, according to the second embodiment, moreover, it is possible to calculate the degree of influence of each block of the image data on the recognition result with higher accuracy while achieving the effect similar to that of the first embodiment described above.

### Third Embodiment

In the first and second embodiments described above, when the degree of influence of each block of the image data on the recognition result is calculated, the error is calculated by using the feature map output from the layer of the hidden layer, and the calculated error (or processed error) is backpropagated to generate the important feature map.

On the other hand, in a third embodiment, the degree of influence of each block of the image data on the recognition result is calculated by using signal intensity of the feature map output from the layer of the hidden layer. Hereinafter, regarding the third embodiment, differences from the first and second embodiments described above will be mainly described.

### < Functional Configuration of Analysis Unit of Image Processing Device>

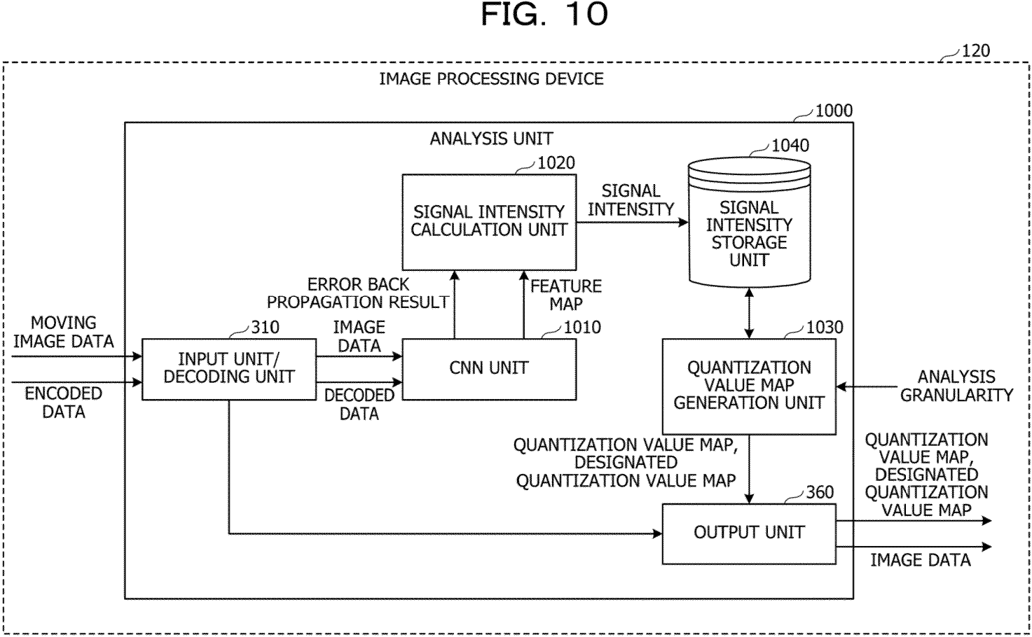

First, a functional configuration of an analysis unit of an image processing device 120 according to the third embodiment will be described. FIG. 10 is a second diagram illustrating an example of the functional configuration of the analysis unit of the image processing device. As illustrated in FIG. 10, an analysis unit 1000 includes an input unit/decoding unit 310, a CNN unit 1010, a signal intensity calculation unit 1020, a quantization value map generation unit 1030, and an output unit 360.

Among these, the input unit/decoding unit 310 and the output unit 360 have functions similar to those of the input unit/decoding unit 310 and the output unit 360 in FIG. 3, and thus, description thereof is omitted here.

The CNN unit 1010 causes a trained model to be executed by inputting image data or decoded data. Furthermore, the CNN unit 1010 outputs a feature map from a layer of a hidden layer when the trained model is executed.

The signal intensity calculation unit 1020 is another example of the first and second acquisition units, acquires the feature map output from the CNN unit 1010, aggregates signal intensity of the acquired feature map in units of blocks, and stores the signal intensity in a signal intensity storage unit 1040. Note that, when aggregating the signal intensity of the feature map in units of blocks, the signal intensity calculation unit 1020 calculates an error between two specified feature maps and backpropagates the calculated error, thereby acquiring an error back propagation result from an input layer of the trained model. Then, the signal intensity calculation unit 1020 generates a block map specifying a positional relationship between each area of the feature map and each block of the image data from a correspondence relationship between the acquired “error back propagation result” and the “error between the feature maps”.

The signal intensity calculation unit 1020 aggregates the signal intensity of the feature map in units of blocks by using the generated block map.

The quantization value map generation unit 1030 is another example of the determination unit, and generates a quantization value map while sequentially changing a quantization value for each block. Furthermore, the quantization value map generation unit 1030 searches for a quantization value corresponding to a limit compression ratio for each block based on an aggregation result of the signal intensity stored in the signal intensity storage unit 1040, and generates a designated quantization value map.

### <Specific Example of Processing of CNN Unit and Signal Intensity Calculation Unit>

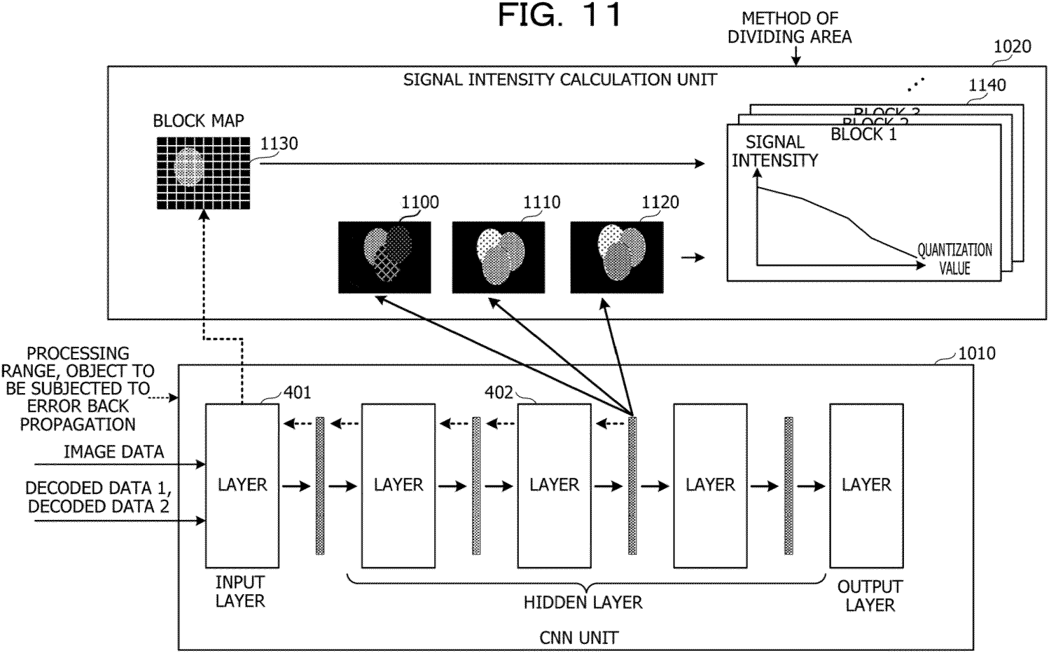

Next, a specific example of processing of the CNN unit 1010 and the signal intensity calculation unit 1020 among the respective units constituting the analysis unit 1000 will be described. FIG. 11 is a diagram illustrating the specific example of the processing of the CNN unit and the signal intensity calculation unit.

As illustrated in FIG. 11, the CNN unit 1010 includes an input layer, hidden layers, and an output layer as the trained model. When image data is input to a layer 401 of the input layer of the CNN unit 1010, the image data is processed in a forward propagation direction in each layer, and a feature map 1100 is output from a layer 402 of the hidden layer.

Similarly, when decoded data 1 is input to the layer 401 of the input layer, the decoded data 1 is processed in the forward propagation direction in each layer, and a feature map 1110 is output from the layer 402 of the hidden layer.

Here, in the signal intensity calculation unit 1020, an error between the feature map 1100 and the feature map 1110 is calculated, and the calculated error is backpropagated from the layer 402 of the hidden layer. With this configuration, an error back propagation result is output from the layer 401 of the input layer of the CNN unit 1010.

In the signal intensity calculation unit 1020, from a correspondence relationship between
· the error back propagation result output from the layer 401 of the input layer, and
· the error between the feature map 1100 and the feature map 1110,
a block map 1130 that specifies a positional relationship indicating to which block among the respective blocks of the image data the signal intensity of each area of the feature maps (the feature map 1100 and the feature map 1110) output from the layer 402 of the hidden layer corresponds is generated.

Note that, it is assumed that an object used to calculate the error to be backpropagated (for example, the image data and the decoded data 1) is instructed as an “object to be subjected to error back propagation” by a user, for example, and is set in advance as a setting value.

Furthermore, in the signal intensity calculation unit 1020, the signal intensity of each feature map output from the layer 402 of the hidden layer is aggregated in units of blocks based on the block map 1130, and a graph 1140 indicating a change in the signal intensity for each block is generated. The graph 1140 is a graph with the quantization value on a horizontal axis and the signal intensity is on a vertical axis, and indicates that the larger the signal intensity, the higher the degree of influence on the recognition result. In the signal intensity calculation unit 1020, the generated graph 1140 is stored in the signal intensity storage unit 1040.

With this configuration, the quantization value map generation unit 1030 determines, for example, the quantization value that satisfies any of the following conditions:
· in a case where magnitude of the signal intensity falls below a predetermined threshold,
· in a case where an amount of change in the signal intensity exceeds a predetermined threshold,
· in a case where a slope of the signal intensity exceeds a predetermined threshold, or
· in a case where a change in the slope of the signal intensity exceeds a predetermined threshold,
as the quantization value corresponding to the limit compression ratio of each block.

Note that, in the description above, the case has been described where the error between the feature map 1100 and the feature map 1110 is backpropagated once when generating the block map 1130. However, the method of backpropagating the error is not limited to this, and for example, the block map 1130 may be generated by dividing the error between the feature map 1100 and the feature map 1110 into a plurality of areas and sequentially backpropagating the errors between the respective areas. Note that the method of backpropagating the error is instructed as a “method of dividing the area” from a user, for example, and is set in advance as a setting value.

### <Flow of Image Processing>

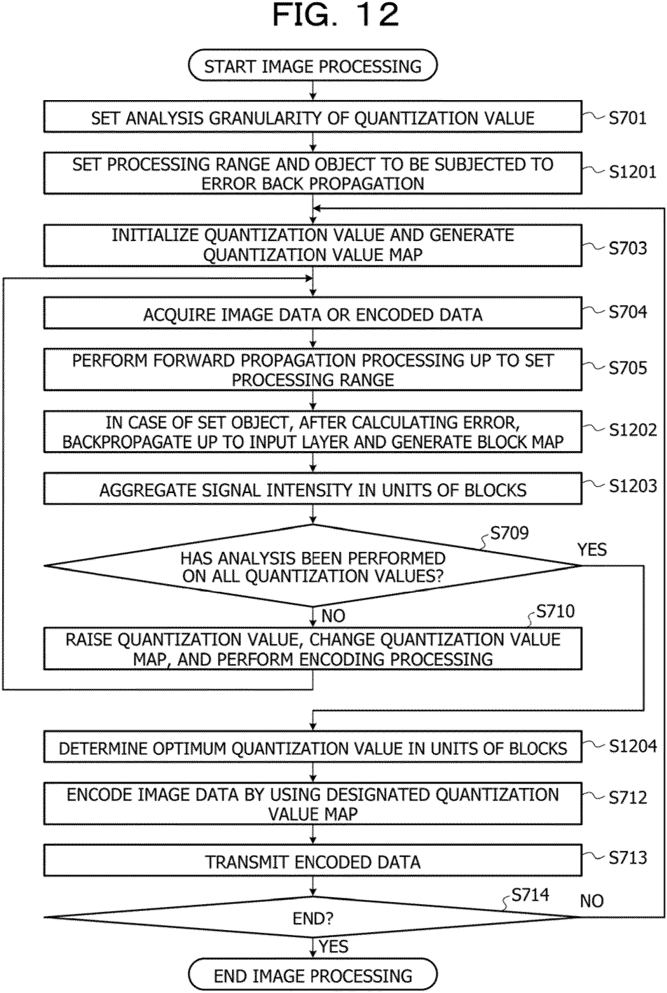

Next, a flow of image processing by the image processing device 120 will be described. FIG. 12 is a third flowchart illustrating the flow of the image processing by the image processing device. Differences from the first flowchart described with reference to FIG. 7 are Steps S1201, S1202, S1203, and S1204.

In Step S1201, the analysis unit 1000 sets a processing range and an object to be subjected to error back propagation (for example, the image data and the decoded data 1).

In Step S1202, in a case where the image data or the decoded data being processed is the object to be subjected to error back propagation (for example, the image data or the decoded data 1), the analysis unit 1000 calculates an error between the feature maps and backpropagates the calculated error up to the input layer. Furthermore, the analysis unit 1000 generates a block map by using an error back propagation result output from the input layer.

In Step S1203, the analysis unit 1000 aggregates signal intensity of each area of the feature map output in Step S705 in units of blocks by using the generated block map.

In Step S1204, the analysis unit 1000 searches for an optimum quantization value in units of blocks based on a change in the signal intensity and generates a designated quantization value map.

As is clear from the above description, the image processing device 120 according to the third embodiment generates the designated quantization value map by aggregating the signal intensity of each area of the feature map output from the layer of the hidden layer in units of blocks.

With this configuration, according to the image processing device 120 according to the third embodiment,
· processing in the forward propagation direction on the next and subsequent layers of the layer 402 of the hidden layer,
· error back propagation up to the layer before the layer 402 of the hidden layer (the next layer in the case of being viewed in the forward propagation direction), and
· error back propagation from the layer 402 of the hidden layer other than the object set as the “object to be subjected to error back propagation”
may be omitted, and an amount of calculation may be reduced.

For example, according to the third embodiment, it is possible to reduce the amount of calculation when the encoding processing suitable for the recognition processing by AI is performed.

### Fourth Embodiment

In the first to third embodiments described above, the description has been made assuming that various setting values are set in advance. On the other hand, in a fourth embodiment, a case will be described where a setting value related to increase or decrease in an amount of calculation or a calculation time among the various setting values is dynamically changed. Hereinafter, the fourth embodiment will be described.

### <Description of Setting Value to Be Dynamically Changed>

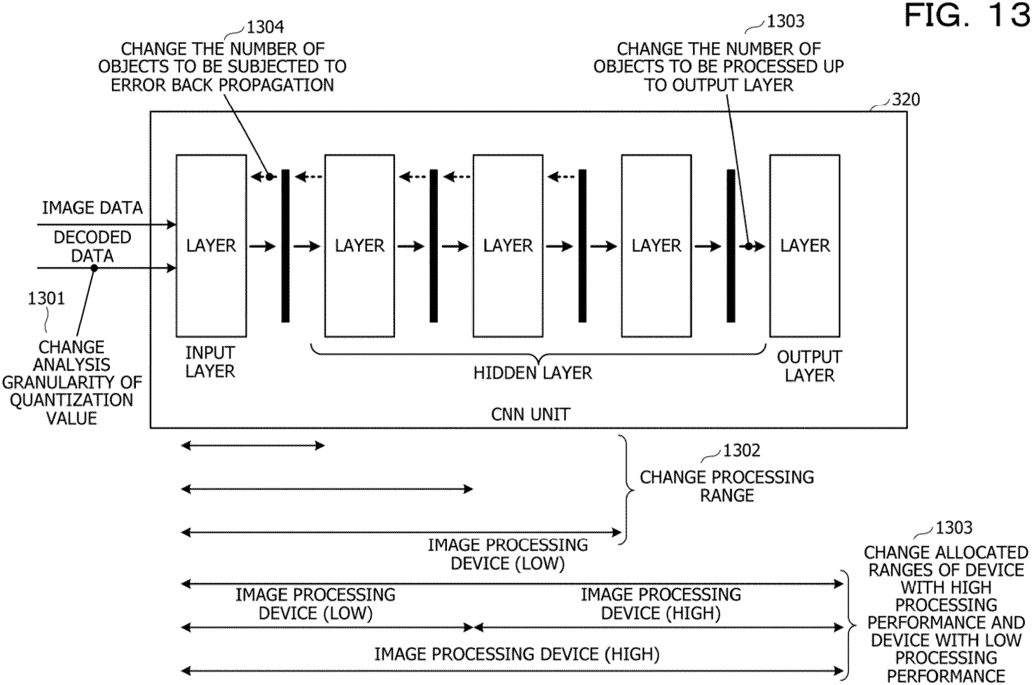

First, the setting value to be dynamically changed (setting value related to the increase or decrease in the amount of calculation or the calculation time) will be described. FIG. 13 is a diagram for describing the setting value to be dynamically changed.

As illustrated in FIG. 13, the setting value to be dynamically changed includes “analysis granularity” of a quantization value (reference sign 1301). When the analysis granularity of the quantization value is made finer, the number of pieces of decoded data input to a CNN unit 320 increases, and when the analysis granularity of the quantization value is made coarser, the number of pieces of decoded data input to the CNN unit 320 decreases. This is because, for example, the amount of calculation of the CNN unit 320 increases or decreases by increasing or decreasing the number of pieces of decoded data input to the CNN unit 320.

Furthermore, as illustrated in FIG. 13, the setting value to be dynamically changed includes a “processing range” (reference sign 1302). When the processing range is widened, the amount of calculation in the CNN unit 320 increases, and when the processing range is narrowed, the amount of calculation in the CNN unit 320 decreases. This is because, for example, the amount of calculation of the CNN unit 320 increases or decreases by enlarging or reducing the processing range.

Furthermore, as illustrated in FIG. 13, the setting value to be dynamically changed includes an allocated range of a device (reference sign 1303). In each of the embodiments described above, the case has been described where the image processing is executed by using one image processing device 120. However, for example, a case is also conceivable where the image processing is executed by using a plurality of image processing devices with different types of processing performance. This is because, in this case, the calculation time increases or decreases by changing the allocated range of each image processing device.

Furthermore, as illustrated in FIG. 13, the setting value to be dynamically changed includes the number of “objects to be processed up to an output layer” (reference sign 1303). In the second embodiment described above, the case has been described where the image data and the decoded data 1 are set as the objects to be processed up to the output layer. However, a case is also conceivable where a plurality of sets of objects to be processed up to the output layer is set. This is because, in such a case, the amount of calculation of the CNN unit 320 increases or decreases by increasing or decreasing the number of objects to be processed up to the output layer.

Furthermore, as illustrated in FIG. 13, the setting value to be dynamically changed includes the number of “objects to be subjected to error back propagation” (reference sign 1304). In the third embodiment described above, the case has been described where, when the block map is generated, the error is divided into the plurality of areas, and the errors in the respective areas are sequentially backpropagated. At this time, when the number of divisions of the error increases, the number of times of error back propagation increases, and when the number of divisions of the error decreases, the number of times of error back propagation decreases. This is because, for example, the amount of calculation of the CNN unit 320 increases or decreases by changing the “method of dividing the area”.

Note that, in the present embodiment, it is assumed that analysis units 121 and 1000 dynamically change the setting values described above based on a predetermined index (for example, the amount of calculation, the calculation time, or the like), for example. For example, in the present embodiment, the analysis units 121 and 1000 function as change units that dynamically change the setting values.

### <Specific Example of Dynamic Change Processing of Setting Value>

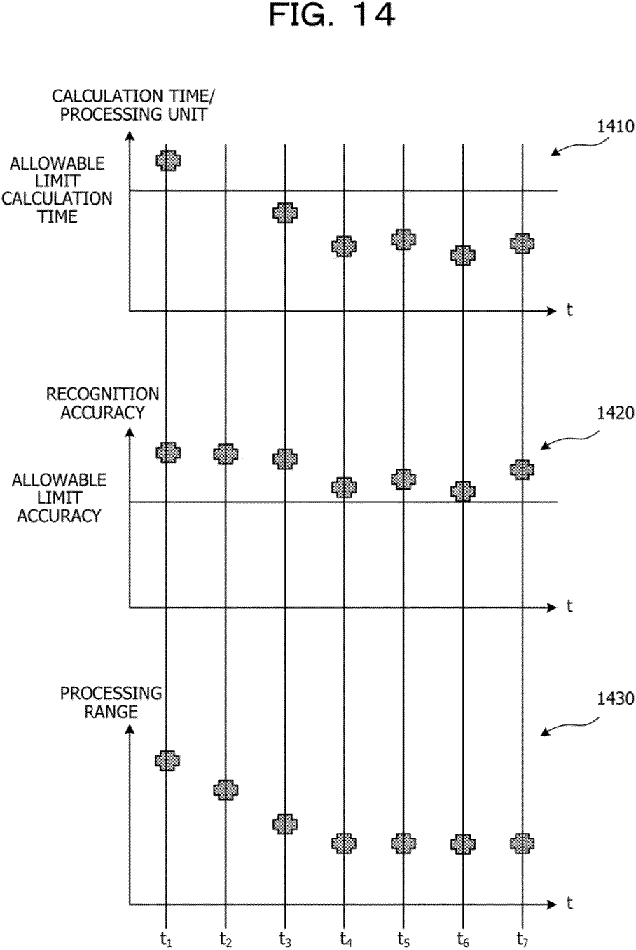

Next, a specific example of processing in a case where the “processing range” among the setting values described above is dynamically changed will be described. FIG. 14 is a diagram illustrating the specific example of the dynamic change processing of the setting value.

In FIG. 14, a graph 1410 is a graph with a calculation time per predetermined processing unit (for example, one frame) (calculation time/processing unit) on a vertical axis and a time on a horizontal axis. Note that, in the graph 1410, an allowable limit calculation time refers to a calculation time per frame that may be allowed to process moving image data in real time.

Furthermore, a graph 1420 is a graph with recognition accuracy on a vertical axis and a time on a horizontal axis. Note that, in the graph 1420, allowable limit accuracy refers to a limit value of recognition accuracy in a case where encoded data encoded by using a designated quantization value map is decoded and the recognition processing is performed on the decoded data. Moreover, a graph 1430 is a graph with a processing range on a vertical axis and a time on a horizontal axis.

In the case of the example of FIG. 14, immediately after the start of the image processing, the calculation time/processing unit exceeds the allowable limit calculation time (time t₁), but the calculation time/processing unit drops to the allowable limit calculation time by dynamically changing the processing range (narrowing the processing range) and reducing the amount of calculation (time t₂).

Furthermore, in the case of the example of FIG. 14, the calculation time/processing unit is significantly below the allowable limit calculation time by further dynamically changing the processing range (narrowing the processing range) and reducing the amount of calculation (times t₃ and t₄). Note that, in the case of the example of FIG. 14, the recognition accuracy approaches the allowable limit accuracy at the timing when the calculation time/processing unit is significantly below the allowable limit calculation time.

Thus, in the example of FIG. 14, the processing range is dynamically changed (the processing range is slightly enlarged), and the amount of calculation is increased (time t₅). With this configuration, while the calculation time/processing unit slightly increases, the recognition accuracy is recovered (time t₅).

Furthermore, in the example of FIG. 14, thereafter, while the processing range is dynamically changed (while the processing range is slightly narrowed or slightly widened), an optimum balance between the calculation time/processing unit and the recognition accuracy is searched for (times t₆ and t₇).

In this manner, by dynamically changing the “processing range”, it is possible to search for an optimum processing range. Note that, in the example of FIG. 14, as an index at the time of searching for an optimum processing range, the “calculation time/processing unit” and the “recognition accuracy” are used, but an index other than these may be used.

As the index other than the calculation time/processing unit and the recognition accuracy, for example, power consumption, an amount of heat generation, or the like of the image processing device 120 is exemplified.

### Other Embodiments

In each of the embodiments described above, the number of layers included in the CNN unit is five due to space limitations, but the number of layers included in the CNN unit may be five or more.

Furthermore, in the first to third embodiments described above, a method of setting various setting values has not been mentioned. However, for example, the various setting values may be set by being input to the server device 130 via the operation device 231 and transmitted to the image processing device 120 via the network. Alternatively, the various setting values may be set by coupling the operation device to the image processing device 120 and directly inputting the various setting values to the image processing device 120 from the coupled operation device.

Note that the embodiments are not limited to the configurations described here and may include, for example, combinations of the configurations or the like described in the embodiments described above and other elements. These points may be changed in a range not departing from the spirit of the embodiments and may be appropriately determined according to application modes thereof.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An image processing device comprising:
a memory; and
a processor coupled to the memory and configured to:
acquire a first feature map output from a hidden layer by forward propagation of image data;
acquire a plurality of second feature maps output from the hidden layer by forward propagation of each of a plurality of pieces of decoded data obtained by sequentially encoding the image data by using different quantization values and thereafter decoding the encoded image data;
calculate a degree of influence of each block of the image data on a recognition result by backpropagating each error between the first feature map and the plurality of second feature maps; and
determine a quantization value of each block when the image data is encoded.

2. The image processing device according to claim 1, wherein the processor:
acquires a third feature map output by backpropagating, up to a layer before the hidden layer, an error between an output result output from an output layer by the forward propagation of the image data and an output result output from the output layer by forward propagation of decoded data obtained by encoding the image data by using a predetermined quantization value and decoding ; and
sets an error of an area that corresponds to the third feature map to zero and backpropagates the error when each error between the first feature map and the plurality of second feature maps is backpropagated.

3. The image processing device according to claim 1, wherein each error between the first feature map and the plurality of second feature maps is calculated by weighting and adding an error between corresponding channels.

4. An image processing device comprising:
a memory; and
a processor coupled to the memory and configured to:
acquire a first feature map output from a hidden layer by forward propagation of image data;
acquire a plurality of second feature maps output from the hidden layer by forward propagation of each of a plurality of pieces of decoded data obtained by sequentially encoding the image data by using different quantization values and thereafter decoding the encoded image data;
calculate a degree of influence of each block of the image data on a recognition result by aggregating signal intensity of each area of the first feature map and the plurality of second feature maps for each block; and
determine a quantization value of each block when the image data is encoded.

5. The image processing device according to claim 4, wherein the processor:
specify a positional relationship between each area of the first feature map and a predetermined second feature map and each block of the image data by backpropagating an error between the first feature map and the predetermined second feature map.

6. The image processing device according to claim 4, wherein the processor:
specify a positional relationship between each area of the first feature map and a predetermined second feature map and each block of the image data by dividing an error between the first feature map and the predetermined second feature map into a plurality of areas and sequentially backpropagating errors of the respective areas.

7. The image processing device according to claim 1, wherein the processor:
encode the image data by using the quantization value.

8. The image processing device according to claim 1, wherein a position of the hidden layer from which each of the first feature map and the second feature maps is acquired or a change interval of the quantization value used when the image data is sequentially encoded is dynamically changed by using, as an index, an amount of calculation, a calculation time, recognition accuracy, an amount of power, or an amount of heat generation.

9. An image processing method comprising:
acquiring a first feature map output from a hidden layer by forward propagation of image data;
acquiring a plurality of second feature maps output from the hidden layer by forward propagation of each of a plurality of pieces of decoded data obtained by sequentially encoding the image data by using different quantization values and thereafter decoding the encoded image data; and
calculating a degree of influence of each block of the image data on a recognition result by backpropagating each error between the first feature map and the plurality of second feature maps, and determines a quantization value of each block when the image data is encoded.
